(19) United States
(12) Patent Application Publication
(10) Pub. No.: US 2011/0012774 A1
(43) Pub. Date: Jan. 20, 2011

(54) RANGE FINDER, SHAPE MEASURING DEVICE, AND METHODS FOR THEM

(75) Inventors: Hiroyuki Sakai, Kyoto (JP); Takeshi Fukuda, Osaka (JP); Kenichi Inoue, Osaka (JP); Toru Sato, Kyoto (JP); Takuya Sakamoto, Kyoto (JP); Yusuke Kani, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/922,327

(22) PCT Filed: Mar. 6, 2009
(86) PCT No.: PCT/JP2009/001012

§ 371 Date: Sep. 13, 2010

(30) Foreign Application Priority Data
Mar. 17, 2008 (JP) 2008-068287

(51) Int. Cl. G01S 13/08; G01S 13/89

(52) U.S. Cl. 342/145

(57) ABSTRACT

The range finder includes a transmitting unit (71) which emits a transmitted wave (75) spread using a spread code at a constant chip rate, a receiving unit (72) which receives a reflected wave (76), a correlation unit (73) which calculates a correlation waveform indicating delay time and a correlation between the transmitted wave (75) and the reflected wave (76), and a distance calculation unit (74) which calculates, from a peak position in the waveform, a distance to the object. The correlation unit (73) calculates the correlation waveform obtained when changing the delay time for each range gate. The distance calculation unit (74) calculates the distance to the object by calculating, at a resolution finer than the range gate, a delay time corresponding to the peak in the correlation wave using a highest-correlation point and an adjacent higher-correlation point in the wave form.

### TECHNICAL FIELD

The present invention relates to range finders which measure distances to objects using spread spectrum radar, and to shape measuring devices which measure shapes of objects using such range finders.

### BACKGROUND ART

In order to find out an external environment of a mobile machine, such as a robot, an automobile, a ship, or an aircraft, from inside or outside thereof, it is important to recognize surrounding objects and shapes of the objects. Shape recognition is more important in terms of avoidance of danger particularly when the mobile machine travels automatically. Moreover, there is a large public demand for human-shape estimation in view of application to security services or nursing care services. As means for estimating shapes of such objects, imaging systems using radar have attracted attention. For example, a UWB radar, which utilizes an ultra-wide band (UWB) signal, can measure a shape of a near-field target at a fine resolution, and therefore, has been used in many applications such as ground probing or nondestructive inspection. However, in conventional ground probing radar imaging, most algorithms for estimating a shape from a measurement result are based on iterative improvement, iterative calculation, or the like, so that it takes a long time to complete shape estimation. It is therefore difficult to directly apply the conventional techniques to a real-time process required for the aforementioned robot and the like.

The present inventors have developed and proposed a high-speed shape estimation algorithm which enables real-time processing, called a shape estimation algorithm based on boundary scattering transform (BST) and extraction of directly scattered waves (SEABED) method. In the SEABED method, a shape of an object is estimated by utilizing a reversible conversion relationship established between a relationship between the shape of the object and a time delay, which is obtained by changing a transmission and reception position, of a scattered wave of a transmission signal (see Patent Reference 1 and Non-Patent References 1 to 5).

In the SEABED method, a shape is estimated using equations for inverse boundary scattering transform. An image obtained by the inverse boundary scattering transform is not an approximate solution but is a mathematically exact solution, and can be directly obtained rather than based on iterative calculations. The SEABED method is an algorithm which enables very fast calculation of fine-resolution imaging in comparison with conventional methods.

### Patent Reference 1: Japanese Unexamined Patent Application Publication Number 2006-343205

### Non-Patent Reference 1: Takuya SAKAMOTO and Toru SATO, A Nonparametric Target Shape Estimation Algorithm for UWB Pulse Radar Systems, IEICE Technical Report, A.P2003-36, Vol. 103, No. 120, pp. 1-6, Jun. 19, 2003

Non-Patent Reference 2: Takuya SAKAMOTO and Toru SATO, A Phase Compensation Algorithm for High-Resolution Shape Estimation Algorithms with Pulse Radars, IEICE Technical Report, A.P2004-72, Vol. 104, No. 202, pp. 37-42, Jul. 22, 2004
Non-Patent Reference 3: Takuya SAKAMOTO and Toru SATO, A Target Shape Estimation Algorithm for Pulse Radar Systems Based on Boundary Scattering Transform, IEICE TRANSACTIONS on Communications, Vol. E87-B, No. 5, May 2004, pp. 1357-1365 Non-Patent Reference 4: Shouhei KIDERA, Takuya SAKAMOTO, and Toru SATO, A Fast Imaging Algorithm with Bi-static Antenna for UWB Pulse Radar Systems, the 34th Electromagnetic Theory Symposium of IEICE, EMT-05-58, November 2005
Non-Patent Reference 5: Shouhei Kidera, Takuya Sakamoto, and Toru Sato, A High-resolution 3-D Imaging Algorithm with Linear Array Antennas for UWB Pulse Radar Systems, IEEE AP-S International Symposium, USNC/URSI National Radio Science Meeting, AMEREM Meeting, pp. 1057-1060, July 2006

### DISCLOSURE OF INVENTION

Problems that Invention is to Solve

For actual imaging application, it should be understood that accuracy of images is a major decisive factor of capability. In the case of imaging using the SEABAD method, accuracy of images is highly dependent on accuracy of distance measurement of radar. In the case where spread spectrum radar is used for real-time imaging, accuracy (resolution) of distance measurement is determined by a chip rate of a code because sampling is usually performed per symbol time period (that is an inverse number of a chip rate of a pseudorandom noise (PN) code, that is, a range gate). A “chip” is a rectangular pulse of a PN code, and the chip rate (cps: chips per second) indicates a change rate of the PN code.

In usual practice, the rate of spread code (PN code) used for spread spectrum radar is limited to several Gcps at the maximum. Accuracy of ranging at such a rate is several centimeters. For example, when a code has a chip rate of 2.5 Gcps, a chip time (range gate), which is the inverse number of the chip rate, is 0.4 ns. In this case, assuming that a transmission rate of a radiowave in air is 3×10⁸ m/s, the resolution is as coarse as 6 cm, which is twice the distance that the radiowave travels in the chip time (range gate) because the radiowave is received after traveling to and from a target.

(a) and (b) of FIG. 11 are drawings showing a maximum accuracy (resolution) of ranging by a range finder in which conventional spread spectrum radar is used. (a) of FIG. 11 shows a positional relationship in actual measurement of distance from an antenna and a metallic sphere using spread spectrum radar. The metallic sphere is placed 40 to 50 cm (44.6 cm, 46.8 cm, 50.3 cm, 52.2 cm) away from the antenna. The chip rate of the spread code of the spread spectrum radar used in the measurement is 2.5 Gcps.

(b) of FIG. 11 shows correlations between transmitted signals and received signals in the four cases shown in (a) of FIG. 11. In ranging using spread spectrum radar, a spectrum of a carrier wave is spread using a code and the carrier wave is emitted as a radar wave, a reflected wave from a target is despread using a code prepared by delaying the code, and frequency components of the carrier wave is extracted from the signal resulting from the despreading. The horizontal axis of (b) of FIG. 11 indicates time delays of the code used for the despreading, that is, distances to the target. The vertical axis of (b) of FIG. 11 indicates powers of the frequency components after the despreading. Although the curve data in (b) of FIG. 11 looks smoothed with respect to the time indicated by the horizontal axis by a filtering process through which the frequency components are extracted, actually obtained are discrete values of peaks of the respective curves at 0.4-ns intervals. As these curves show, maximum peaks of the correlations for 46.8 cm and 50.3 cm are observed at the same position because ranging is performed at intervals of a time of the inverse number of the chip rate (that is, the range gate, 0.4 ns for this case). Thus, these two distances cannot be distinguished by detecting maximum peaks as in the conventional manner. In other words, there is a problem that conventional techniques cannot provide resolutions finer than a range gate.

However, in some imaging applications, accuracy of the order of millimeters is required, with increase in accuracy by more than one order of magnitude.

A possible way of increasing accuracy of ranging is to increase the bitrate of the spread code, but this not only increases cost because a high-performace code generator is necessary but also is very difficult to achieve because of such high technical hurdles for increasing the bitrate only by an order of magnitude.

The present invention, conceived to address this problem, has an object of providing a range finder which measures distance using spread spectrum reader at high accuracy and moderate cost and a high-accuracy shape measuring device in which the range finder is used.

### Means to Solve the Problems

In order to achieve the above object, the range finder according to the present invention is a range finder which measures a distance to an object using spread spectrum radar and includes: a transmitting unit configured to generate a signal having a spectrum spread using a spread code expressed at a constant chip rate, and to emit the signal toward the object; a receiving unit configured to receive the signal reflected from the object; a correlation unit configured to calculate a correlation waveform which indicates how a correlation between a waveform of the signal received by the receiving unit and a waveform of the signal emitted from the transmitting unit changes depending on a time delay from the emission to the reception; and a distance calculation unit configured to calculate the distance to the object by identifying a peak in the correlation waveform calculated by the correlation unit, wherein the correlation unit is configured to calculate the correlation waveform which indicates the change in the correlation with changes in the time delay for respective range gates each of which is a time duration corresponding to the chip rate, and the distance calculation unit is configured to calculate the distance to the object by calculating, at a resolution finer than the range gates, a time delay corresponding to the peak in the correlation waveform, using a highest-correlation point and an adjacent higher-correlation point, the highest-correlation point being a point at which the correlation is maximum in the correlation waveform, and the adjacent higher-correlation point being one of two points immediately before and after the highest-correlation point and a point at which the correlation is higher than at the other.

With this, the time delay corresponding to the peak is calculated at a resolution finer than the range gate using the two points in the correlation waveform. This therefore enables measurement of distance at range accuracy (resolution) finer than determined by the chip rate using a simple method, or at lower cost.

Note that the “peak” of the correlation waveform in the description of the present invention is a true (or calculated) peak of the correlation waveform. In other words, it is a point at which correlation is maximum among not only discrete, actually measured points on the correlation waveform but also points which interpolate between the actually measured points.

Furthermore, in order to achieve the above object, the shape measuring device according to the present invention measures a shape of an object using spread spectrum radar and includes: a plurality of transmitting units configured to generate signals each having a spectrum spread using a spread code expressed at a constant chip rate, and to emit the signals toward the object; a receiving unit configured to receive the signals reflected from the object; a correlation unit configured to calculate correlation waveforms which indicate how correlations between waveforms of the signals received by the receiving unit and waveforms of the respective signals emitted from transmitting units which are among the transmitting units and have emitted the signals received by the receiving unit change depending on time delays from the emissions to the receptions; and a shape estimation unit configured to extract a quasi-wavefront by identifying peaks in the correlation waveforms calculated by the correlation unit so as to calculate distances from the transmitting units to the object, and to estimate the shape of the object based on a relation between the extracted quasi-wavefront and the object, wherein the correlation unit is configured to calculate the correlation waveforms which indicate the change in the correlations with changes in the time delays for respective range gates each of which is a time duration corresponding to the chip rate, and the shape estimation unit is configured to calculate the distances to the object by calculating, at a resolution finer than the range gates, time delays corresponding to the peaks in the correlation waveforms, using a highest-correlation point and an adjacent higher-correlation point, the highest-correlation point being a point at which the correlation is maximum in each of the correlation waveforms, and the adjacent higher-correlation point being one of two points immediately before and after the highest-correlation point and a point at which the correlation is higher than at the other.

With this, the time delay corresponding to the peak is calculated at a resolution finer than the range gate using the two points on the correlation waveform. This therefore enables measurement of distance at range accuracy (resolution) finer than determined by the chip rate using a simple method, or at lower cost, and achieves highly accurate imaging.

This also enables real-time imaging including measurement and signal processing by considerably reducing measurement time using a technique of transmitting different signals at the same time from transmitters, that is, what is called code multiplexing.

The present invention may be implemented not only as a range finder or a shape measuring device but also as a method of distance measurement or a method of shape measurement in which components of the range finder or the shape measuring device are implemented as steps, as a program in which the steps are described, a recording medium such as a CD-ROM in which the program is stored or a semiconductor integrated circuit such as an LSI.

### Effects of the Invention

According to the present invention, distance measurement at a resolution finer than a distance equivalent to a chip rate of a spread code is achieved to provide a range finder which measures distance at moderate cost and high accuracy, and a high-accuracy shape measuring device for which the range finder is employed.

Furthermore, using a technique of code multiplexing which enables real-time imaging, they have extremely high practical value as a range finder and a shape measuring device to find out environment around mobile machines such as a robot.

### BRIEF DESCRIPTION OF DRAWINGS

FIG. 1 is a block chart which shows a configuration of a range finder according to Embodiment 1 of the present invention.

FIG. 2 is a flowchart which shows a detailed procedure of operation of a distance calculation unit of the range finder.

FIG. 3 shows an exemplary correlation waveform calculated by a correlation unit of the range finder.

FIG. 4 shows an exemplary calibration curve which the distance calculation unit of the range finder holds beforehand.

FIG. 5 is a block chart which shows a configuration of a shape measuring device according to Embodiment 2 of the present invention.

FIG. 6 is a diagram for describing positioning of antennas in a SEABED method.

FIG. 7 including (a) and (b) is a diagram for describing a boundary scattering transform.

FIG. 8 is a flowchart showing a procedure for measuring a shape of an object using the SEABED method.

FIG. 9 including (a) and (b) shows a result of actual measurement of a quasi-wavefront using the shape measuring device according to Embodiment 2 of the present invention.

FIG. 10 including (a) and (b) is a diagram for describing a result of the shape estimation using the SEABED method on the basis of the quasi-wavefront shown in (a) and (b) of FIG. 9.

FIG. 11 including (a) and (b) is a drawing showing a maximum accuracy (resolution) of ranging by a range finder in which conventional spread spectrum radar is used.

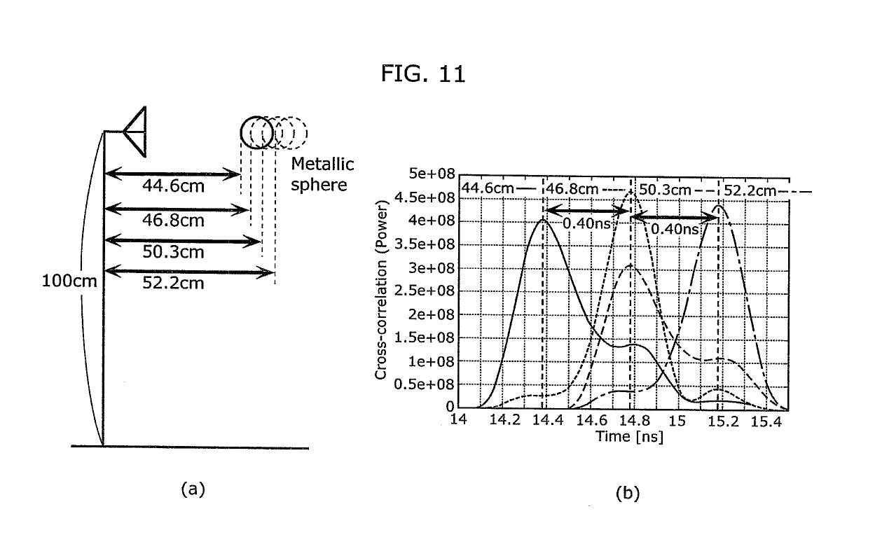

### NUMERICAL REFERENCES

0, 77 Object (Target)

5 Shape estimation circuit

5a, 74 Distance calculation unit

11, 13, 15, 17, 71d Transmitting antenna

12, 14, 16, 18, 72a Receiving antenna

21 to 24 Signal generation unit

31 to 34 Receiver

41 to 44 Correlation circuit

51 to 54 Radar

70 Range finder

71 Transmitting unit

71a Oscillator

71b PN code generation unit

71c Spreader

72 Receiving unit

73 Correlation unit

73a Variable delay unit

73b Despreader

73c Narrow-band filter

74a Calibration curve

75 Transmission wave (radar wave)

76 Reflected wave

80 Shape measuring device

### BEST MODE FOR CARRYING OUT THE INVENTION

Hereinafter, an embodiment of a range finder and a shape measuring device according to the present invention will be described with reference to the drawings.

### Embodiment 1

Hereinafter, an embodiment of a range finder according to the present invention will be described with reference to drawings.

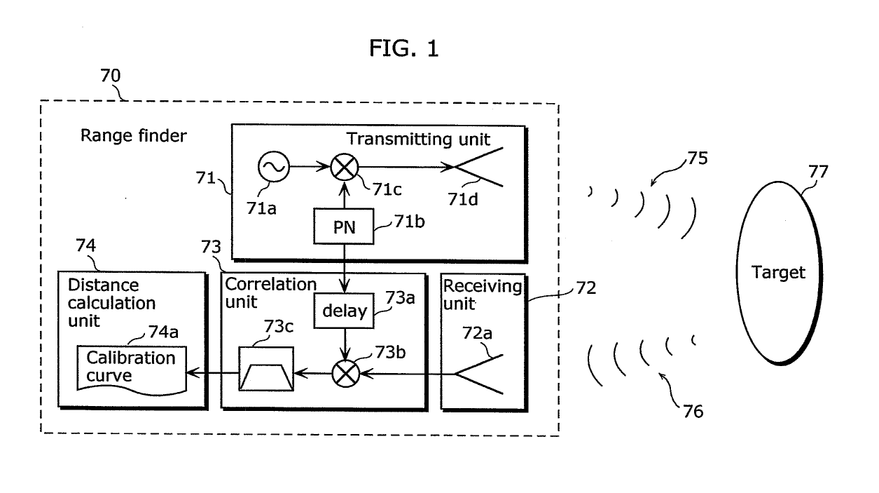

FIG. 1 is a block diagram showing a configuration of a range finder 70 according to the present invention. FIG. 1 also includes a target (object) 77 which is an object of ranging.

The range finder 70 is a device which measures distance to the target 77 using spread spectrum radar and includes a transmitting unit 71, a receiving unit 72, a correlation unit 73, and a distance calculation unit 74.

The transmitting unit 71 generates a signal with a spectrum spread by a spread code expressed at a constant chip rate and emits the signal toward the target 77. The transmitting unit 71 includes, for example, an oscillator 71a which generates a sine wave (carrier wave) of 26 GHz band, a PN code generation unit 71b which generates a pseudorandom noise (PN) code (that is, the spread code), a spreader 71c which spreads the spectrum of the sine wave (or modulates the sine wave) using the spread code, and a transmitting antenna 71d which transmits a signal resulting from the spreading.

The receiving unit 72 is a processing unit which receives a signal reflected from the target 77 and includes, for example, a receiving antenna 72a.

The correlation unit 73 is a processing unit which calculates a correlation waveform. The correlation waveform indicates how correlation between the waveform of the signal received by the receiving unit 72 and the waveform of the signal emitted from the transmitting unit 71 changes depending on a time delay from the emission to the reception of the signal. The correlation unit 73 includes a variable delay unit 73a which delays the spread code generated by the PN code generation unit 71b while changing (sweeping) the time delay, a despreader 73b which despreads (demodulates) the signal received by the receiving antenna 72a using the PN code provided from the variable delay unit 73a, and a narrow-band filter 73c which passes only frequency components of the sine wave, which is generated by the oscillator 71a, of the despread signal. Note that the correlation unit 73 calculates a correlation waveform which indicates the change in the correlation with the changes (sweep) in the time delay for respective range gates each of which is a time duration corresponding to the chip rate.

The distance calculation unit 74 is a processing unit which calculates a distance from the range finder 70 (precisely, a transmitting and receiving antenna) to the target 77 by identifying a peak of the correlation calculated by the correlation unit 73. More specifically, the distance calculation unit 74 calculates a distance to the target 77 by calculating a time delay corresponding to the peak in the correlation waveform at a resolution finer than the range gate using a highest-correlation point, which is a point at which the correlation is maximum in the correlation waveform, and an adjacent higher-correlation point, which is one of two points immediately before and after the highest-correlation point and a point at which the correlation is higher than at the other. The distance calculation unit 74 for this processing may be implemented as a computer provided with specific software, a CPU, a memory, and input and output units.

The distance calculation unit 74 identifies one of the range gates which is a time duration from the highest-correlation point to the adjacent higher-correlation point. Here, it is assumed that one of these two points at which the time delay is smaller than at the other is a first point and the other at which the time delay is smaller than at the first point is a second point. Next, the distance calculation unit 74 calculates a ratio between the correlation at the first point and the correlation at the second point, identifies the time position of the peak in the range gate based on the calculated ratio, and then calculates, from the time delay corresponding to the determined time position of the peak, the distance to the target 77.

More specifically, the distance calculation unit 74 holds a calibration curve 74a beforehand, which indicates how the ratio between the correlation at the first point and the correlation at the second point changes depending on any of a time position of a peak in a range gate, a time delay corresponding to the time position, or on a distance corresponding to the time position (that is, a distance which a radiowave travels in the time). With reference to the calibration curve 74a, the distance calculation unit 74 calculates the distance to the target 77 by identifying any of the time position, the time delay, or the distance corresponding to the ratio calculated from the correlation waveform calculated by the correlation unit 73.

The calibration curve 74a is a curve which indicates, at intervals of a distance smaller than a distance corresponding to the range gate (that is, the distance which a radiowave travels in the time), the ratio changes depending on distance. The distance calculation unit 74 thus calculates the distance to the target 77 at a resolution finer than the range gate by identifying, with reference to the calibration curve 74a, a distance corresponding to the ratio calculated from the correlation waveform calculated by the correlation unit 73.

Hereinafter, operation of the range finder 70 according to the present invention (that is, the principle of the ranging) will be described with reference to the drawings.

Initially, the spectrum of the signal generated by the oscillator 71a is spread by the spreader 71c using a spread code generated by the PN code generation unit 71b, and emitted to be a transmitted wave (that is, a radar wave) 75 from the transmitting antenna 71d toward the target 77. Next, the reflected wave 76 reflected from the target 77 is received by the receiving antenna 72a, and then despread by the despreader 73b using a signal which the variable delay unit 73a prepares, by delaying for the time t1, from the spreading signal generated by the PN code generation unit 71b.

Here, in the case where the time delay ti for which the variable delay unit 73a has delayed the signal is equal to the time from the emitting of the transmitted wave 75 to the receiving of the reflected wave 76 reflected from the target 77, the spread code included in the signal provided from the receiving antenna 72a to the despreader 73b coincides with the spread code from the variable delay unit 73a. The despreader 73b therefore restores a narrow-band signal generated by the oscillator 71a. If the time delay t1 is not equal to the time, the signal despread by the despreader 73b remains spread over a wide band. Thus, by filtering the signal despread by the despreader 73b using the narrow-band filter 73c, a signal is extracted only in the case where the time delay of the spread code is equal to the time from the emitting of the radar wave 75 by the range finder 70 to the receiving of the radar wave 75 reflected from the target 77. The time taken by the radar wave 75 to reach the target 77 and return to the range finder 70 is time taken by a radiowave to travel twice the distance to the target 77, and hence the distance from the range finder 70 to the target 77 can be calculated.

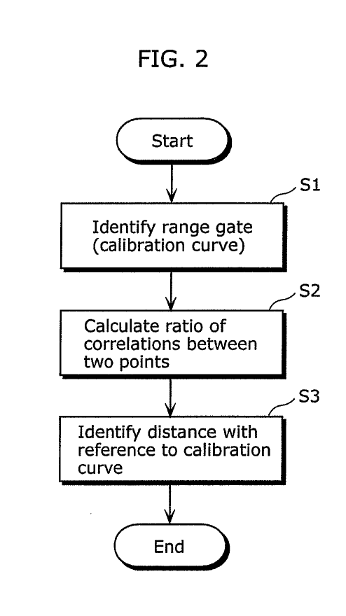

Hereinafter, operation of the distance calculation unit 74 of the range finder 70 according to the present invention will be described in detail with reference to the drawings. FIG. 2 is a flowchart showing a detailed procedure of the distance calculation unit 74.

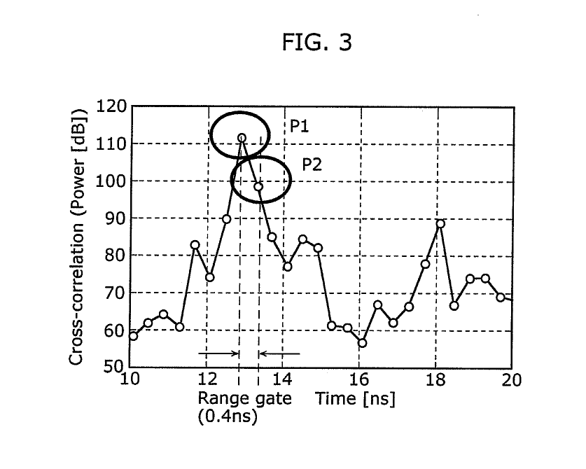

As shown in FIG. 3, the distance calculation unit 74 identifies a range gate which is a time duration from a highest-correlation point (a point P1 in FIG. 3), at which the correlation is maximum, to an adjacent higher-correlation point (a point P2 in FIG. 3), at which the correlation is higher than at the other point of two points immediately before and after the point at which the correlation is maximum, in the correlation waveform calculated by the correlation unit 73, that is, the curve which indicates relationship between the time delay caused by the variable delay unit 73a and the power of the signal provided from the narrow-band filter 73c (S1). Note that in the case where the distance calculation unit 74 holds a plurality of calibration curves corresponding to respective range gates, the distance calculation unit 74 identifies a calibration curve corresponding to the identified range gate to perform the process in Step S3 described below using the identified calibration curve.

Next, the distance calculation unit 74 calculates a ratio between the correlation at the highest-correlation point (the point P1 in FIG. 3) and the adjacent higher-correlation point (the point P2 in FIG. 3) (S2). In FIG. 3, the correlation at one of these two points at which the time delay is smaller than at the other (the point P1 in FIG. 3) is approximately 112 dB and the correlation at the other point at which the time delay is larger the one (the point P2 in FIG. 3) is approximately 98 dB. The ratio is thus approximately 14 dB for this case.

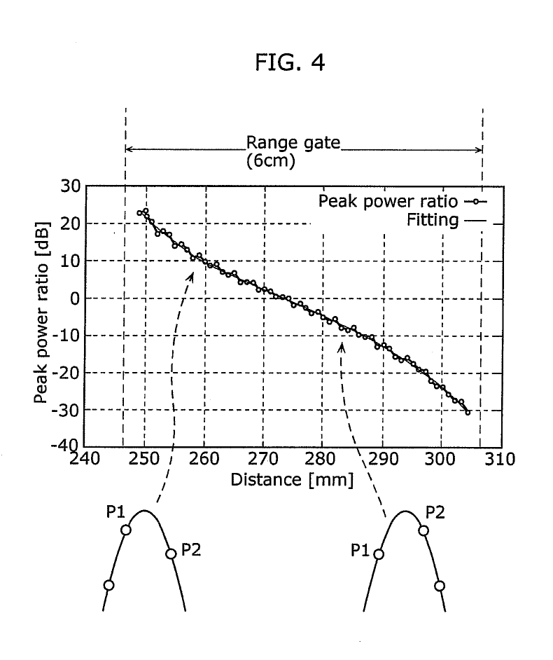

The distance calculation unit 74 then determines a distance corresponding to the ratio calculated in Step S2 with reference to the calibration curve 74a which the distance calculation unit 74 holds beforehand as shown in FIG. 4 (the calibration curve corresponds to the range gate identified in Step S1) (S3). Note that the vertical axis in FIG. 4 indicates ratios between the correlation at one point, of the highest-correlation point and the correlation at the adjacent higher-correlation point, at which the delay time is smaller than at the other point and the correlation at the other point, and that the horizontal axis in FIG. 4 indicates time positions of peaks in range gates identified in Step 1 (the distance between the range finder 70 and the target in Embodiment 1).

The calibration curve 74a is a curve obtained by actual measurement in advance as shown in FIG. 4. Specifically, the ratios are measured at intervals of distances smaller than the range gate to find change in the ratio depending on the distance, and a smooth curve fitted to the data thus obtained is provided as the calibration curve 74a. For the point at which the correlation is maximum in the correlation waveform and the point at which the correlation is higher than at the other point of two points immediately before and after the point at which the correlation is maximum, one point at which the time delay is smaller than at the other is a first point and the other point is a second point. The ratio (indicated as values on the vertical axis) between a correlation at the first point and a correlation at the second point is larger as the true peak is located further left (in the direction of smaller time delays) in the range gate between the two points as shown in FIG. 4. Thus, the correlation waveform shows a monotonic decrease (from positive to negative) with an increase in time delay.

The distance calculation unit 74 thus calculates the distance to the target 77 at a resolution finer than the range gate by determining, with reference to the calibration curve 74a, a distance corresponding to the ratio calculated from the correlation waveform calculated by the correlation unit 73.

Although the horizontal axis of the calibration curve 74a shown in FIG. 4 indicates absolute distance between a range finder and a target, the distance calculation unit 74 may hold a calibration curve 74a with a horizontal axis which indicates displacement within a range gate (for example, 0 to 60 mm). In this case, the distance calculation unit 74 determines an offset distance (a distance corresponding to the left edge of the range gate) per range gate (in a unit of 0.4 ns and a unit of 60 mm) on the basis of the position of the range gate identified in Step S1. Furthermore, the distance calculation unit 74 determines a distance smaller than the range gate (a fractional distance) through the processes of Steps S2 and S3, and finally calculates the distance to the target at a resolution finer than the range gate by adding the offset distance and the fractional distance.

### Embodiment 2

Hereinafter, an embodiment of a shape measuring device according to the present invention (Embodiment 2) will be described with reference to the drawings.

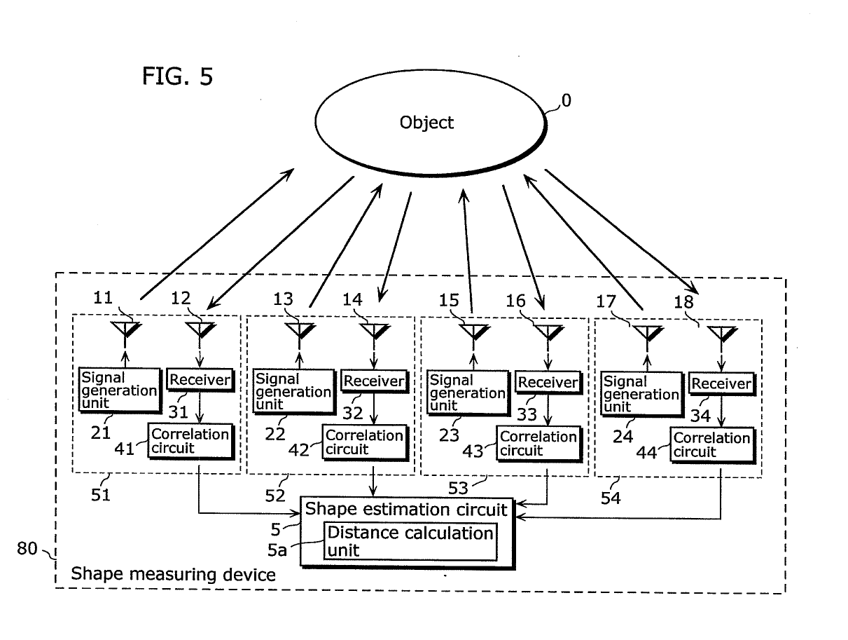

FIG. 5 is a diagram showing an example circuit configuration of a shape measuring device 80 according to Embodiment 2 in which spread spectrum radar is used.

The shape measuring device 80 of the present embodiment includes a plurality of radars and a shape estimation circuit as shown in FIG. 5. Specifically, the shape measuring device 80 of the present embodiment includes radars 51, 52, 53, and 54 provided at different positions and a shape estimation circuit 5 which receives signals output from the radars 51 to 54.

Each of the radars 51 to 54 has a signal generation unit which generates an electric signal, a transmitting antenna which emits the electric signal generated by the signal generation unit as a transmitted radiowave into space, a receiving antenna which receives a reflected wave of the transmitted radiowave reflected from a target object 0and converts the wave into a received wave, a receiver which receives the received wave, and a correlation circuit which receives an output of the receiver. Specifically, the radar 51 has a signal generation unit 21, a transmitting antenna 11, a receiving antenna 12, a receiver 31, and a correlation circuit 41. The radar 52 has a signal generation unit 22, a transmitting antenna 13, a receiving antenna 14, a receiver 32, and a correlation circuit 42. The radar 53 has a signal generation unit 23, a transmitting antenna 15, a receiving antenna 16, a receiver 33, and a correlation circuit 43. The radar 54 has a signal generation unit 24, a transmitting antenna 17, a receiving antenna 18, a receiver 34, and a correlation circuit 44.

Note that the number of radars is not limited to four and may be larger. Although an example in which the radars 51 to 54 are linearly arranged in a plane as shown in FIG. 5 for the sake of simplicity will be described, radars may be arranged in a two-dimensional array so as to two-dimensionally measure a shape of the object 0. Although a transmitting antenna and a receiving antenna are preferably separately provided when a code is used, a single antenna (transmitting and receiving antenna) may be used both for transmission and reception. Note that the transmitted radio wave preferably has a fractional bandwidth, which is a ratio of an occupied bandwidth to a center frequency, of 20% or more.

Next, measurement operation will be described using the radar 51 as an example. Initially, the signal generation unit 21 generates, for example, a 26-GHz band sine wave (carrier wave), and modulates (or spreads the spectrum of) the carrier wave using a pseudorandom noise (PN) code. The modulation is performed by phase modulation, for example. For example, the carrier wave and the pseudorandom noise code are input into a double balanced mixer circuit including Gilbert cells and multiplied therein, whereby a phase-modulated transmission signal can be easily generated. A signal which is emitted as a transmitted wave from the transmitting antenna 11 is reflected from the object 0, and part of the signal is received by the receiving antenna 12. Thereafter, a received wave output from the receiving antenna 12 may be amplified, shaped (filtered) in the receiver 31 before being transferred as a received signal to the correlation circuit 41. The correlation circuit 41 calculates a correlation waveform by calculating a correlation between the received signal and a reference signal. Specifically, the received signal is demodulated using the same PN code as that for the transmitted signal (what is called despreading), and is down-converted using the carrier wave, thereby calculating the correlation waveform.

The radars 52 to 54 also simultaneously perform operation similar to that of the radar 51, and transfer respective correlation waveforms to the shape estimation circuit 5. Places where the radars 51 to 54 are placed are directly used as measurement positions, whereby correlation waveforms at first to fourth measurement positions are obtained.

Next, using the SEABED method described later, the shape estimation circuit 5 obtains locations where maximums of absolute values of the correlation waveforms received from the radars 51 to 54 are, extracts a quasi-wavefront, and outputs a shape of the object by inverse boundary scattering transform. The shape estimation circuit 5 has a distance calculation unit 5a which has the same function as that of the distance calculation unit 74, that is, a distance calculation unit 5a which calculates a distance to an object by calculating a time delay corresponding to a peak in a correlation waveform at a resolution finer than range gates, using a highest-correlation point, which is a point at which the correlation is maximum in each of the correlation waveforms, and an adjacent higher-correlation point, which is one of two points immediately before and after the highest-correlation point and a point at which the correlation is higher than at the other. Using a similar method, the distance calculation unit 5a identifies local maximums and local minimums in correlation waveforms at a resolution finer than a range gate.

The principle of the SEABED method will be described below. The SEABED method described below is a method in which technique of code multiplexing using a plurality of antennas is employed.

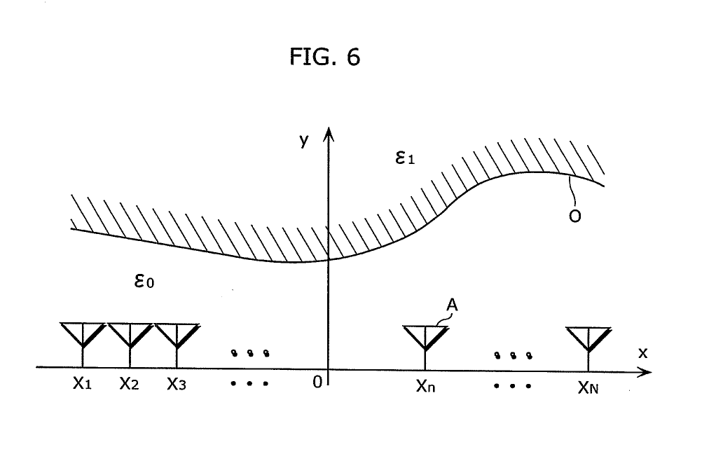

FIG. 6 is a diagram describing positioning of antennas in the SEABED method. In this SEABED method, it is assumed that an object to be measured is a physical object which has a distinct boundary, and the boundary is measured to obtain a “quasi-wavefront”. A shape of the object to be measured is calculated by inverse-transforming the quasi-wavefront.

In this description of the principle, a two-dimensional problem is dealt with, assuming that a target object O and transmitting and receiving antennas are provided in the same plane. It is also assumed that radiowaves propagate as transverse electric (TE) waves. Space in which the target object O and the transmitting and receiving antennas are present is referred to as an “r-domain”, and expression to be used for expressing a set in the r-domain is referred to as “expression in the r-domain”. A point in the r-domain is expressed in (x, y). Here, both x and y (y>0) are normalized using the center wavelength λ of a transmission pulse in vacuum. The transmitting and receiving antennas are assumed to be omnidirectional and repeatedly transmit and receive monocycle pulses at respective measurement positions xₙ (n is an integer of 1 to N) spaced at predetermined intervals (for example, regular intervals) on the x-axis in the r-domain. A reception electric field at a measurement position (x, y)=(X, 0) of each of the transmitting and receiving antennas is defined as s′(X, Y), and Y is defined as Y=(c×t)/(2×λ), where t is a period of time from transmission to reception and c is the speed of light in vacuum. Note that y>0 and therefore Y>0. A time t at which an instantaneous envelope at a measurement position xₙ of the transmitting and receiving antenna is maximum is assumed to be zero.

In addition, for the purpose of removing noise, a matched filter whose impulse response waveform is identical to a transmitted wave is applied to s′(X, Y) in the Y-direction, and the form of a received wave obtained by the application of the matched filter is newly defined as s(X, Y). The s(X, Y) is used as data for calculating a shape of the target object O. Space expressed in (X, Y) is referred to as a “d-domain”, and expression to be used for expressing a set in the d-domain is referred to as “expression in the d-domain”. X and Y are normalized using the center wavelength and the center time duration of a transmission pulse, respectively.

Change in the complex permittivity ε(x, y) of the target object O having a continuous boundary surface is assumed to provide a set of piecewise differentiable curves. Specifically, the complex permittivity ε(x, y) of the target object O is expressed by EQ. 1.

$$\begin{matrix}[ Math . 1 ] & \\ {\vert ∇ ɛ ( x , y ) \vert}^{2} = {\sum }_{q ∈ H} {a}_{q} δ ( y - {g}_{q} ( x ) ) & EQ . 1\end{matrix}$$

Here, it is assumed that g_{q}(x) is a differentiable single-valued function, and q={(x, y)|y=g_{q}(x), x ε q} ε H, where Jq is the domain of definition of the function g_{q}(x), a_{q} is a positive constant depending on q εH, and H is the set of all q's. Elements of H are on a “target boundary surface”.

A subset P of the d-domain is defined by EQ. 2

[Math. 2]

P={(X,Y)|∂s(X,Y)/∂Y=0} EQ. 2

With respect to a connected closed set p ⊂P, a domain Ip is defined by EQ. 3.

[Math. 3]

Iₚ=[min_{(x,y)εp}X, max_{(x,y)εp}] EQ. 3

A single-valued function fp(X) is present which has the domain of definition Ip with respect to p if there is only one Y satisfying (X, Y) ε p with respect to an arbitrary X ε Ip. A set of p's for which the function fp(X) is differentiable and |∂fp(X)/∂X|≦1 is defined as G, and elements of G are referred to as a “quasi-wavefront”.

When EQ. 1 is satisfied, direct scattered waves from a boundary hold information about a target boundary surface (expressing a surface and a shape of the target object O). This is similarly established in a known medium through which direct waves are propagated at a constant speed, although it is hereinafter assumed for the sake of simplicity that all the propagation paths of direct waves are in vacuum.

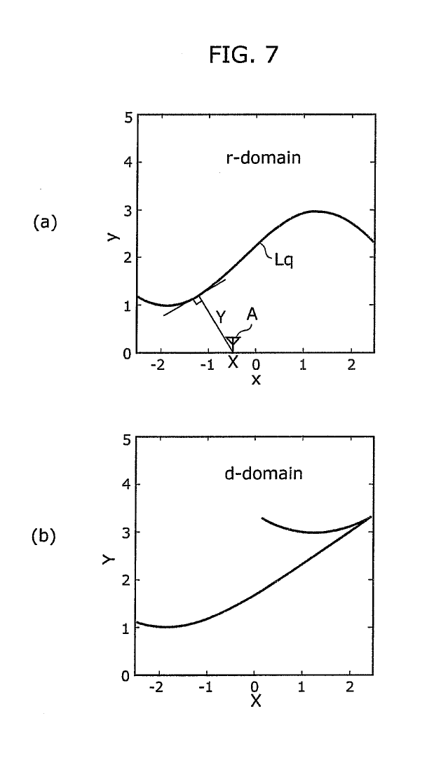

(a) and (b) of FIG. 7 show a boundary scattering transform. (a) of FIG. 7 shows an example of change in complex permittivity in the r-domain, and (b) of FIG. 7 shows a quasi-wavefront of the d-domain corresponding to the r-domain shown in (a) of FIG. 7.

If it is assumed that p corresponds to direct scattering from q, it can be seen from (a) of FIG. 7 that a point (X, Y) on p is expressed by EQ. 4 using a relationship between the length of a perpendicular line from the transmitting and receiving antenna to a curve Lq expressed by q, and the position of the transmitting and receiving antenna. A transform expressed by EQ. 4 is hereinafter referred to as a boundary scattering transform.

$$\begin{matrix}[ Math . 4 ] & \\ \{ \begin{matrix}X = x + y d y / d x \\ Y = y \sqrt{1 + {( \frac{d y}{d x} )}^{2}}\end{matrix} & EQ . 4\end{matrix}$$

Note that (x, y) is a point on q.

By calculating an inverse transform of this boundary scattering transform, the shape of the target object O can be calculated from the form of a received wave. This inverse transform is calculated using EQ. 5. This inverse transform is hereinafter referred to as an inverse boundary scattering transform.

$$\begin{matrix}[ Math . 5 ] & \\ \{ \begin{matrix}x = X - Y d Y / d X \\ y = Y \sqrt{1 - {( \frac{d Y}{d X} )}^{2}}\end{matrix} & EQ . 5\end{matrix}$$

Although two-dimensional measurement has been described above, the SEABED method can be easily extended to three-dimensional measurement. Also, although it has been assumed above that the transmitting and receiving antennas are installed along a straight line, an equation of transform corresponding to a case where the transmitting and receiving antennas are installed along any curve can be easily obtained.

For example, a boundary scattering transform for a three-dimensional problem is expressed by EQ. 6, and its inverse transform is calculated using EQ. 7.

$$\begin{matrix}[ Math . 6 ] & \\ \{ \begin{matrix}X = x + z \partial z / \partial x \\ Y = y + z \partial z / \partial y \\ Z = z \sqrt{1 + {( \frac{\partial z}{\partial x} )}^{2} + {( \frac{\partial z}{\partial y} )}^{2}}\end{matrix} & EQ . 6 \\ [ Math . 7 ] & \\ \{ \begin{matrix}x = X - Z \partial Z / \partial X \\ y = Y - Z \partial Z / \partial Y \\ z = Z \sqrt{1 - {( \frac{\partial Z}{\partial X} )}^{2} - {( \frac{\partial Z}{\partial Y} )}^{2}}\end{matrix} & EQ . 7\end{matrix}$$

In the SEABED method in which the shape of the target object O is estimated from the form of a received wave using EQ. 5 (EQ. 7 for a three-dimensional measurement), the shape of the target object O is specifically measured by executing the following process.

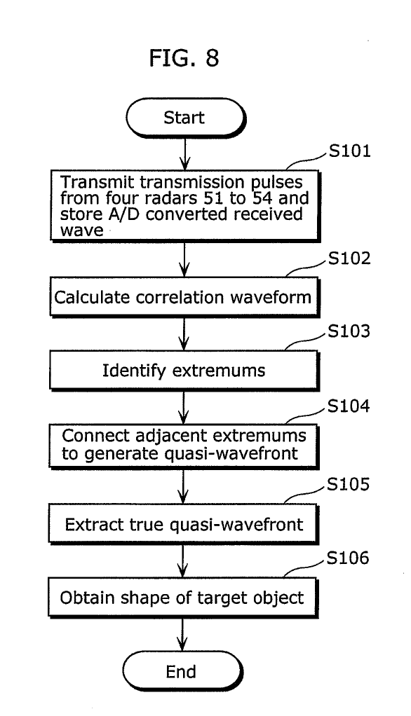

FIG. 8 is a flowchart showing a procedure for measuring a shape of an object using the SEABED method.

Referring to FIG. 8, in the SEABED method, the shape measuring device 80 transmits monocycle pulses (transmission pulses) from omnidirectional transmitting and receiving antennas at respective measurement positions xₙ, receives reflected waves of the transmission pulses reflected from the target object O, performs analog-to-digital conversion (hereinafter abbreviated as “A/D conversion”) on the received waves, and stores the resultant waves as shown in FIG. 6 (Step S101).

Specifically, the shape measuring device 80 transmits a monocycle pulse (transmission pulse) from the omnidirectional transmitting and receiving antenna at the measurement position x₁, receives a reflected wave of the transmission pulse reflected from the target object O, performs A/D conversion on the received wave to generate a first received signal, and stores the first received signal. Simultaneously, the shape measuring device 80 transmits a monocycle pulse (transmission pulse) from the omnidirectional transmitting and receiving antenna at the measurement position x₂ which is a predetermined distance apart from the measurement position x₁, receives a reflected wave of the transmission pulse reflected from the target object O, performs A/D conversion on the received wave to generate a second received signal, and stores the second received signal. Thereafter, similarly, at each measurement position xₙ (from the measurement position x₁ to a measurement position x_{N}), the shape measuring device 80 transmits a monocycle pulse (transmission pulse) from the transmitting and receiving antenna, receives a reflected wave of the transmission pulse reflected from the target object O, performs A/D conversion on the received wave, and stores the resultant received signal. Thus, the first received signal at the measurement position x₁ to an N-th received signal at the measurement position x_{N are obtained.}

A correlation waveform is then transmitted from each of the radars 51 to 54 to the shape estimation circuit 5 shown in FIG. 5.

Next, in Step S102, the shape estimation circuit 5 of the shape measuring device 80 calculates a cross-correlation between a waveform of each of the first to N-th received signals and a waveform of a reference signal, thereby calculating first to N-th correlation waveforms corresponding to the first to N-th received signals, respectively. A correlation function ρ(τ) is expressed by EQ. 8, where τ is a time delay, r(t) is the reference signal, and s(t) is the received signal. Note that the integration range is a range within which the received signal s(t) exists.

[Math. 8]

ρ(τ)=∫s(t)·r(t+τ)dt EQ. 8

Here, the waveform of the reference signal is the waveform of the transmission pulse, which is based on the assumption that the waveform of the received signal has the same shape as that of the transmission pulse. The process of this step corresponds to application of a matched filter to the received signal.

Next, in Step S103, the distance calculation unit 5a of the shape estimation circuit 5 identifies extremums (local maximums and local minimums) in the first to N-th correlation waveforms.

Specifically, the distance calculation unit 5a identifies an extremum by calculating a time delay corresponding to the peak in each of the correlation waveform at a resolution finer than a range gate, using a point at which each of the correlation is maximum in the correlation waveform and one point at which the correlation is higher than at the other point of two points immediately before and after the point at which the correlation is maximum in the correlation waveform. For example, the distance calculation unit 5a identifies a range gate which is between a point at which the correlation is maximum in the correlation waveform and a point at which the correlation is higher than at the other point of two points immediately before and after the point at which the correlation is maximum. Here, it is assumed that one of the two points at which time delay is smaller is a first point and the other is a second point. Next, the distance calculation unit 5a calculates the ratio between the correlation at the first point and the correlation at the second point, and then identifies a true peak (extremum) in the range gate based on the calculated ratio. More specifically, the distance calculation unit 5a holds a calibration curve 74a beforehand which indicates how the ratio between the correlation at the first point and the correlation at the second point changes depending on a time position of a true peak, and obtains a true extremum corresponding to the ratio calculated from the correlation waveform with reference to the calibration curve 74a.

Next, in Step S104, the shape estimation circuit 5 connects adjacent extremums. More specifically, the shape estimation circuit 5 connects extremums in a manner such that EQ. 9 is satisfied.

[Math. 9]

−1≦(position of extremum Mₙ−position of extremum Mₙ₋₁)/(measurement position xₙ−measurement position xₙ₋₁)≦1 EQ. 9

Here, the position of an extremum Mₙ is the position in an XY plane of an extremum calculated from an n-th correlation waveform calculated at the measurement position xₙ. A curve obtained by connecting the extremums in this manner is a quasi-wavefront.

Next, in Step S105, the shape estimation circuit 5 extracts a true quasi-wavefront. Quasi-wavefronts obtained in the process of Step S104 include undesired quasi-wavefronts, such as the one generated due to noise, the one generated by extracting a vibrating portion, and the one generated due to multiple scattering. It is therefore necessary to remove such undesired quasi-wavefronts so as to extract a true quasi-wavefront which truly indicates a boundary surface of the object O. In this process of extracting a true quasi-wavefront, an evaluation value wₚ which is defined by EQ. 10 is firstly used to select and extract a quasi-wavefront having an evaluation value wₚ which is larger than a predetermined threshold α. If the threshold α is excessively small, a large number of undesired quasi-wavefronts are also selected and extracted. If the threshold a is excessively large, a true quasi-wavefront is also removed. Therefore, the threshold a is experimentally or empirically set in view of the maximum value of the evaluation value wₚ.

[Math. 10]

Wₚ=|∫_{XεI}_{ₚ}s(X,fₚ(X))dX|² EQ. 10

The evaluation value wₚ takes a large value when a received signal on a quasi-wavefront has a large amplitude and the domain of definition of fp(X) is wide.

Here, using only EQ. 10 to extract a true quasi-wavefront may give a large evaluation value wₚ when a quasi-wavefront due to, for example, noise is present close to the true quasi-wavefront, and therefore the quasi-wavefront due to noise may not be removed.

When (x, y) ε p1 and (x, y) ε p2 where p1, p2 ε G, p1≠p2 and wₚ1≦wₚ2, a quasi-wavefront is divided, that is, p1 is divided into p1′ and p1″ (p1′∪p1″=p1 and p1′∩p1″=p1∩p2) to obtain the evaluation value wₚ thereby removing undesired quasi-wavefronts.

Thereafter, in the process of extracting a true quasi-wavefront, Fp (known as a first Fresnel zone) expressed by EQ. 11 and a new evaluation value Wp defined by EQ. 12 are secondly used to select and extract a quasi-wavefront having an evaluation value Wp larger than a predetermined threshold β. If the threshold β is excessively small, a large number of undesired quasi-wavefronts are also selected and extracted. If the threshold β is excessively large, a true quasi-wavefront is also removed. Therefore, the threshold β is experimentally or empirically set in view of the maximum value of the evaluation value Wp.

$$\begin{matrix}[ Math . 11 ] & \\ {F}_{P} = \{ \begin{matrix}( {x}_{0} , {y}_{0} ) \vert \sqrt{{( x - {x}_{0} )}^{2} + {( y - {y}_{0} )}^{2}} + \\ \sqrt{{( X - {x}_{0} )}^{2} + {y}_{0}^{2}} - \sqrt{{( x - X )}^{2} + {y}^{2}} < 1 / 2\end{matrix} \} & EQ . 11 \\ [ Math . 12 ] & \\ {w}_{p} = Wp - {\sum }_{q \neq p ∈ G} {w}_{q} \frac{{\int }_{( x , y ) ∈ B [ q ] , Fp} ξ ( x ) d x}{{\int }_{x ∈ Iq} ξ ( x ) d x} & EQ . 12\end{matrix}$$

The evaluation value Wp takes a smaller value when another boundary surface having a large value is present in the Fresnel zone of a quasi-wavefront. ξ(x) is a weight function. For example, for the sake of simplicity, ξ(x) is set to 1.

A true quasi-wavefront thus extracted is a set of time periods, at respective measurement positions, from transmitting of transmission pulses which perpendicularly impinge on tangent planes of a surface of the target object O to direct receiving of reflected waves of the transmission pulses reflected from the surface.

Next, in Step S106, the shape estimation circuit 5 obtains the shape of the object O using EQ. 5 from the true quasi-wavefront extracted in Step S105.

Thus, in the SEABED method, the shape of the target object O can be directly estimated by the inverse transform expressed by EQ. 5. Therefore, the shape of the object O can be considerably quickly measured.

In the SEABED method described above, a shape can be estimated by the inverse boundary scattering transform expressed by EQ. 5 or 7. An image obtained by the inverse boundary scattering transform is not an approximate solution but is a mathematically exact solution, and can be directly obtained rather than based on iterative calculations. These advantages make the SEABED method an imaging algorithm which allows calculation at a finer resolution than conventional methods and at considerably high speed.

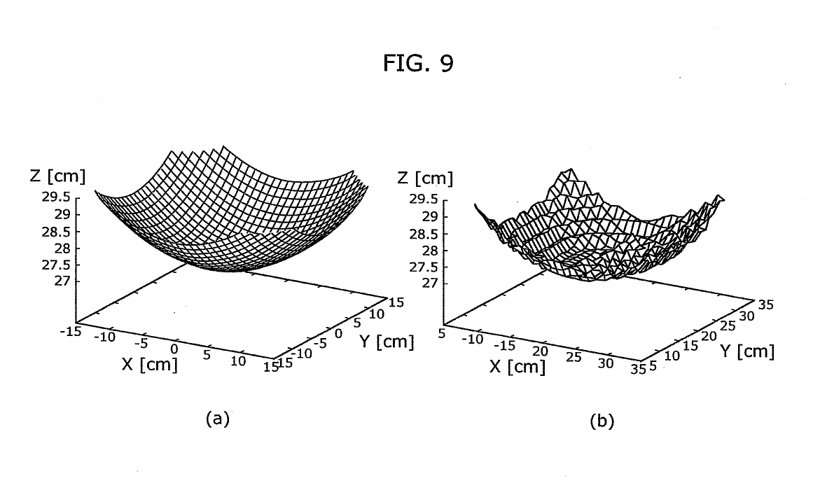

(a) and (b) of FIG. 9 show an example of a quasi-wavefront actually measured using spread spectrum radar and a calibration curve as performed in the shape measuring device 80 according to the present invention. An object to be measured is a wok having a width of 33 cm and a depth of 11 cm and placed at a distance of 27 cm from the antenna. In order to test the effect of use the calibration curve in this measuring, the code is not multiplexed and the object is scanned at 1-cm intervals across 24 cm in the direction of the X axis and 24 cm in the direction of the Y axis with transmitting and receiving antennas adjacent to each other. Values obtained in the measuring are plotted. (a) of FIG. 9 shows an actual distance (a true quasi-wavefront) and (b) of FIG. 9 shows a distance (a quasi-wavefront) measured using the shape measuring device 80 according to Embodiment 2. The RMS value of the error in the measurement is 0.16 cm and the accuracy of the measurement is much higher than accuracy of 6 cm of a conventional method in which no calibration curve is used.

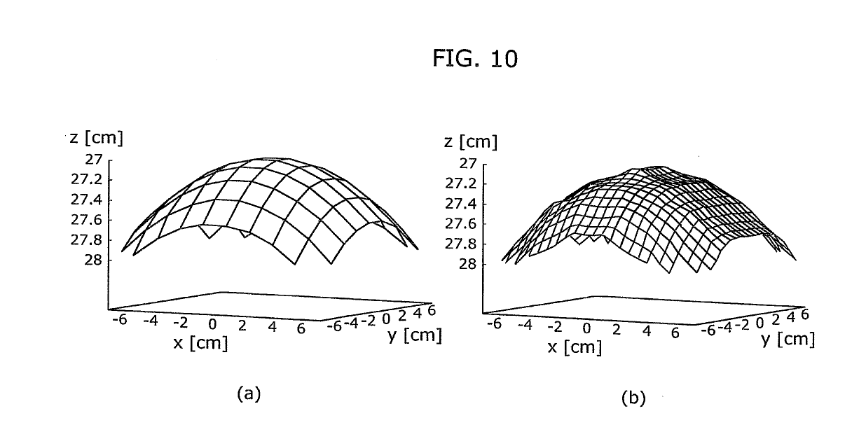

(a) and (b) of FIG. 10 show a result of shape estimation using the SEABED method on the basis of the quasi-wavefronts shown in (a) and (b) of FIG. 9. (a) of FIG. 10 shows an actual shape and (b) of FIG. 10 shows a result of shape estimation by the shape measuring device 80 according to Embodiment 2. The RMS value of errors in the estimated image is 1.2 mm. This shows that the imaging performed by the shape measuring device 80 according to Embodiment 2 is accurate enough.

As described above, in the shape measuring device 80 according to Embodiment 2, the distance calculation unit 5a of the shape estimation circuit 5 identifies extremums (local maximums and local minimums) in the first to N-th correlation waveforms at a resolution finer than the range gate, and the shape of the object is therefore determined at low cost and high accuracy.

Furthermore, in the shape measuring device 80 according to Embodiment 2, what is called a code multiplex technique is used in which different codes are simultaneously transmitted from a plurality of transmitters, measurement time is therefore saved so much that imaging including measurement and signal processing can be performed on a real-time basis.

The present invention is not limited to the range finder and the shape measuring device according to the present invention described above using Embodiments 1 and 2. The present invention also includes variations of the embodiments above and different embodiments in which the respective components in these embodiments above are used in any combination unless they depart from the spirit and scope of the present invention.

For example, a calibration curve of the present invention is not limited to the calibration curve 74a with the horizontal axis indicating distances to an object as shown in FIG. 4. A horizontal axis may indicate time delays by the variable delay unit 73a or relative time delays of a range gate. A distance to the target may be calculated by converting a time delay calculated with reference to the calibration curve into distance.

Although the calibration curve 74a shown in FIG. 4 is for one range gate, such a calibration curve may be prepared for each of all the range gates within the detection range of the radar. This allows accurate measurement of distance to a target in any range gate. It is a matter of course that more accurate measurement is achieved using a calibration curve prepared for each of the range gates through measurement of a relation between distance and ratio between a correlation at the first point and the correlation at the second point for each of the range gates in advance.

In the case where it is unknown which range gate a target is in, a general method of ranging is as follows: first, calibration curves for range gates are held; next, correlation waveforms shown in FIG. 3 are obtained in normal measuring; next, a range gate is identified which is present between a point at which the correlation is maximum in the correlation waveform and one point at which the correlation is higher than at the other point of two points immediately before and after the point at which the correlation is maximum; and a calibration curve for the range gate is then selected and used for estimating the position within the range gate.

Although a calibration curve is provided in Embodiments 1 and 2 using a correlation ratio between two adjacent points, a table of signal powers at three points, that is, a maximum peak and points immediately before and next to the peak may be prepared instead which is equivalent to the calibration curve. Calibration using more points will increase accuracy of ranging. Note that this complicates a system configuration and makes time necessary for the processing longer.

Although in Embodiment 2, the shape estimation circuit 5 is provided with one distance calculation unit 5a, each of the four radars 51 to 54 may be provided with a distance calculation unit which calculates a distance obtained by each of the radars.

### INDUSTRIAL APPLICABILITY

The present invention is applicable as a range finder which measures a distance to an object and as a shape measuring device which measures a shape of an object using spread spectrum radar, such as mobile machines such as a robot, an automobile, a ship, and an aircraft, and a device to be used for finding out an external environment from inside or outside of these mobile machines.

1. A range finder which measures a distance to an object using spread spectrum radar, said range finder comprising:
a transmitting unit configured to generate a signal having a spectrum spread using a spread code expressed at a constant chip rate, and to emit the signal toward the object;
a receiving unit configured to receive the signal reflected from the object;
a correlation unit configured to calculate a correlation waveform which indicates how a correlation between a waveform of the signal received by said receiving unit and a waveform of the signal emitted from said transmitting unit changes depending on a time delay from the emission to the reception; and
a distance calculation unit configured to calculate the distance to the object by identifying a peak in the correlation waveform calculated by said correlation unit,
wherein said correlation unit is configured to calculate the correlation waveform which indicates the change in the correlation with changes in the time delay for respective range gates each of which is a time duration corresponding to the chip rate, and
said distance calculation unit is configured to calculate the distance to the object by calculating, at a resolution finer than the range gates, a time delay corresponding to the peak in the correlation waveform, using a highest-correlation point and an adjacent higher-correlation point, the highest-correlation point being a point at which the correlation is maximum in the correlation waveform, and the adjacent higher-correlation point being one of two points immediately before and after the highest-correlation point and a point at which the correlation is higher than at the other.

2. The range finder according to claim 1,
wherein said distance calculation unit is configured to (i) identify one of the range gates which is a time duration from the highest-correlation point to the adjacent higher-correlation point, (ii) calculate a ratio between the correlation at a first point and the correlation at a second point, the first point being one of the highest point and the higher point and at a time delay smaller than the second point, and the second point being the other of the highest point and the higher point and at a time delay larger than the first point, (iii) identify a time position of the peak in the range gate based on the calculated ratio, and (iv) calculate, from a time delay corresponding to the time position of the identified peak, the distance to the object.

3. The range finder according to claim 2,
wherein said distance calculation unit is configured to hold a calibration curve beforehand which indicates how a ratio between a correlation at a first point and a correlation at the second point changes depending on a time position of the peak in the range gate, a time delay corresponding to the time position, or a distance corresponding to the time position, and calculate the distance to the object by identifying, with reference to the calibration curve, the time position, the time delay, or the distance any of which corresponds to the ratio calculated from the correlation waveform.

4. The range finder according to claim 3,
wherein the calibration curve is a curve which indicates, at intervals of a distance smaller than a distance corresponding to the range gate, how the ratio changes depending on the distance, and
said distance calculation unit is configured to calculate the distance to the object by identifying, with reference to the calibration curve, the distance corresponding to the ratio calculated from the correlation waveform.

5. A range finding method for measuring a distance to an object using spread spectrum radar, said method comprising:
generating a signal having a spectrum spread using a spread code expressed at a constant chip rate, and emitting the signal toward the object;
receiving the signal reflected from the object;
calculating a correlation waveform which indicates how a correlation between a waveform of the signal received in said receiving and a waveform of the signal emitted in said transmitting changes depending on a time delay from the emission to the reception; and
calculating the distance to the object by identifying a peak in the correlation waveform calculated in said calculating of a correlation waveform,
wherein, in said calculating of a correlation waveform, the correlation waveform is calculated which indicates the change in the correlation with changes in the time delay for respective range gates each of which is a time duration corresponding to the chip rate, and
in said calculating of a distance, the distance to the object is calculated by calculating, at a resolution finer than the range gates, a time delay corresponding to the peak in the correlation waveform, using a highest-correlation point and an adjacent higher-correlation point, the highest-correlation point being a point at which the correlation is maximum in the correlation waveform, and the adjacent higher-correlation point being one of two points immediately before and after the highest-correlation point and a point at which the correlation is higher than at the other.

6. A shape measuring device which measures a shape of an object using spread spectrum radar, said shape measuring device comprising:
a plurality of transmitting units configured to generate signals each having a spectrum spread using a spread code expressed at a constant chip rate, and to emit the signals toward the object;
a receiving unit configured to receive the signals reflected from the object;
a correlation unit configured to calculate correlation waveforms which indicate how correlations between waveforms of the signals received by said receiving unit and waveforms of the respective signals emitted from transmitting units which are among said transmitting units and have emitted the signals received by said receiving unit change depending on time delays from the emissions to the receptions; and
a shape estimation unit configured to extract a quasi-wavefront by identifying peaks in the correlation waveforms calculated by said correlation unit so as to calculate distances from said transmitting units to the object, and to estimate the shape of the object based on a relation between the extracted quasi-wavefront and the object,
wherein said correlation unit is configured to calculate the correlation waveforms which indicate the change in the correlations with changes in the time delays for respective range gates each of which is a time duration corresponding to the chip rate, and
said shape estimation unit is configured to calculate the distances to the object by calculating, at a resolution finer than the range gates, time delays corresponding to the peaks in the correlation waveforms, using a highest-correlation point and an adjacent higher-correlation point, the highest-correlation point being a point at which the correlation is maximum in each of the correlation waveforms, and the adjacent higher-correlation point being one of two points immediately before and after the highest-correlation point and a point at which the correlation is higher than at the other.

7. A shape measuring method for measuring a shape of an object using spread spectrum radar, said method comprising:
generating signals each having a spectrum spread using a spread code expressed at a constant chip rate, and emitting the signals from a plurality of transmitting units toward the object;
receiving the signal reflected from the object;
calculating correlation waveforms which indicate how correlations between waveforms of the signals received in said receiving and waveforms of the respective signals emitted from transmitting units which are among the transmitting units and have emitted the signals received in said receiving change depending on time delays from the emissions to the receptions; and
extracting a quasi-wavefront by identifying peaks in the correlation waveforms obtained in said calculating of correlation waveforms, so as to calculate distances from the transmitting units to the object, and estimating the shape of the object based on a relation between the extracted quasi-wavefront and the object,
wherein, in said calculating of correlation waveforms, the correlation waveforms are calculated which indicate the change in the correlation with changes in the time delay changed for respective range gates each of which is a time duration corresponding to the chip rate, and
in said estimating of a shape, the distances to the object are calculated by calculating, at a resolution finer than the range gate, time delays corresponding to the peaks in the correlation waveforms, using a highest-correlation point and an adjacent higher-correlation point, the highest-correlation point being a point at which the correlation is maximum in each of the correlation waveforms, and the adjacent higher-correlation point being one of two points immediately before and after the highest-correlation point and a point at which the correlation is higher than at the other.
